(19) United States
(12) Patent Application Publication
(10) Pub. No.: US 2017/0071818 A1
(43) Pub. Date: Mar. 16, 2017

(54) HANDHELD MASTURBATION CUP

(71) Applicant: HONG KONG PASSKEY INDUSTRY CO,LIMITED, KOWLOON (HK)

(72) Inventor: XIANGRU Chen, BoLuo (CN)

(21) Appl. No.: 14/854,453

(22) Filed: Sep. 15, 2015

(51) Int. Cl. A61H 19/00; B65D 6/00; B65D 8/00

(52) U.S. Cl. CPC A61H 19/32; B65D 11/02; B65D 11/20; A61H 2205/087

(57) ABSTRACT

This disclosure relates to masturbation products, in particular to a handheld masturbation cup including a soft plastic body, a channel formed in the soft plastic body and provided for male masturbation, a hard cup casing installed at the outer side of the soft plastic body and having a grasping recess formed separately on both sides of the hard cup casing, and a handholding soft pad formed at the grasping recess by a secondary plastic injection molding process, so that a user may press the soft plastic body through the handholding soft pad. When the handheld masturbation cup is used, the user not only may perform masturbation through a thrusting motion only, but also may press the soft plastic body through the handholding soft pad to achieve a better masturbation effect.

### TECHNICAL FIELD

The technical field relates to a masturbation product, in particular to a handheld masturbation cup (which is a male masturbation device).

### BACKGROUND

In general, conventional male masturbation devices available in the market are mainly divided into the following types: 1. A soft plastic body is formed by SEBS powder and oil through the mixing, heating, and injecting processes, and a channel (such as a channel that simulates a female vagina, etc) is formed in the soft plastic body and provided for male masturbation, and a relatively harder cup casing is made of ABS or PE and formed on an outer side of the soft plastic body. Such male masturbation device has the following shortcoming. When the masturbation device is used, a user has to hold the relatively harder cup casing and perform thrusting and vibrating actions to achieve the masturbation effect, and thus the masturbation effect is poor. 2. Only one soft plastic body with a channel used for male masturbation is available, and such male masturbation device has the shortcomings of permeating oil, adhering dust, becoming sticky, and having a pungent odor easily.

### SUMMARY

Therefore, it is a primary objective of this disclosure to overcome the aforementioned shortcomings of the prior art by providing a specially designed handheld masturbation cup.

To achieve the aforementioned objective, this disclosure provides a handheld masturbation cup comprising a soft plastic body, a channel formed in the soft plastic body and provided for male masturbation, and a hard cup casing formed on an outer side of the soft plastic body, and grasping recesses are formed on both sides of the hard cup casing respectively, and the grasping recess has a handholding soft pad formed by a secondary plastic injection molding process, so that a user may press the soft plastic body through the handholding soft pad.

Wherein, the soft plastic body is made of a thermoplastic rubber (TPR) material, and the hard cup casing is made of an acrylonitrile butadiene styrene (ABS) plastic material, and the handholding soft pad is made of a thermoplastic polyurethane (TPU) plastic material.

Wherein, the hard cup casing is a cylindrical casing, and the hard cup casing of the cylindrical casing is formed by two half cup casings which are half-cylindrical casings, and the two half cup casings are engaged with each other by an ultrasonic welding process, and both of the two half cup casings have the grasping recess and the handholding soft pad.

Wherein, the inner side of the handholding soft pad is attached closely with the outer side of the soft plastic body when the soft plastic body is installed into the hard cup casing.

Wherein, the hard cup casing further comprises a vibrating device installed therein, and the vibrating device comprises a motor installed to a rear motor cover situated at the rear of the motor, and a motor battery compartment installed at the front of the motor, and the rear motor cover and the motor battery compartment are engaged with each other, and a switch button is installed on an outer side of the rear motor cover, and a motor fixing plate and a rubber ring are installed in the rear motor cover, and a battery is installed in the motor battery compartment, and a control circuit board is installed on a side of the motor battery compartment, and a waterproof silicone cover is installed at the front of the motor battery compartment.

The handheld masturbation cup of this disclosure has the following beneficial effect:

When the masturbation cup is used, the user not only may perform masturbation through a thrusting motion only, but also may press the soft plastic body through the handholding soft pad to achieve a better masturbation effect.

### BRIEF DESCRIPTION OF THE DRAWINGS

FIG. 1 is a perspective view of a handheld masturbation cup in accordance with this disclosure; and

FIG. 2 is an exploded view of a handheld masturbation cup in accordance with this disclosure.

### DESCRIPTION OF THE PREFERRED EMBODIMENTS

This disclosure will become clearer in light of the following detailed description of an illustrative embodiment described in connection with the drawings. It is intended that the embodiments and drawings disclosed herein are to be considered illustrative rather than restrictive.

The handheld masturbation cup of this disclosure comprises a soft plastic body, a channel (which generally simulates a female vagina) formed in the soft plastic body and provided for male masturbation, a hard cup casing installed on an outer side of the soft plastic body, and grasping recesses formed separately on both sides of the hard cup casing, and a handholding soft pad formed at the grasping recess by a secondary plastic injection molding process, so that a user may press the soft plastic body through the handholding soft pad. When the masturbation cup is used, the user not only may perform masturbation by a thrusting motion, but also may press the soft plastic body through the handholding soft pad to achieve a better masturbation effect.

Preferably, the soft plastic body is made of a TPR material to provide a texture similar to human body and a better sense of reality, and the hard cup casing is made of an ABS plastic material, so that the hard cup casing has a certain hardness to facilitate the user to hold the masturbation cup easily and install other components conveniently, and the handholding soft pad is made of a TPU material to provide a relatively softer and more elastic handholding soft pad and allow the user to press the soft plastic body through the soft pad by fingers more effectively.

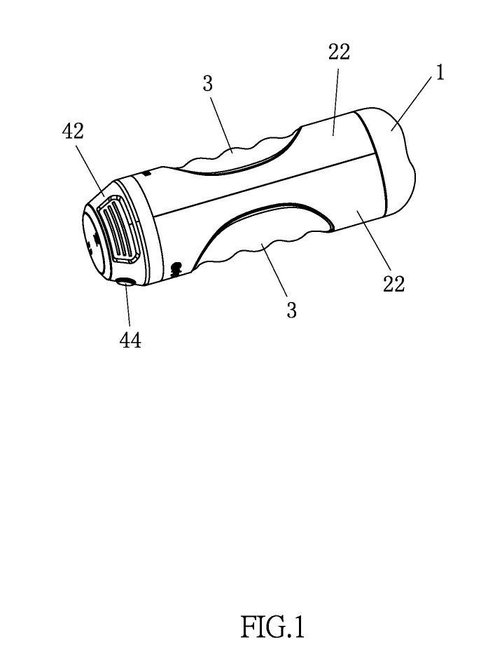

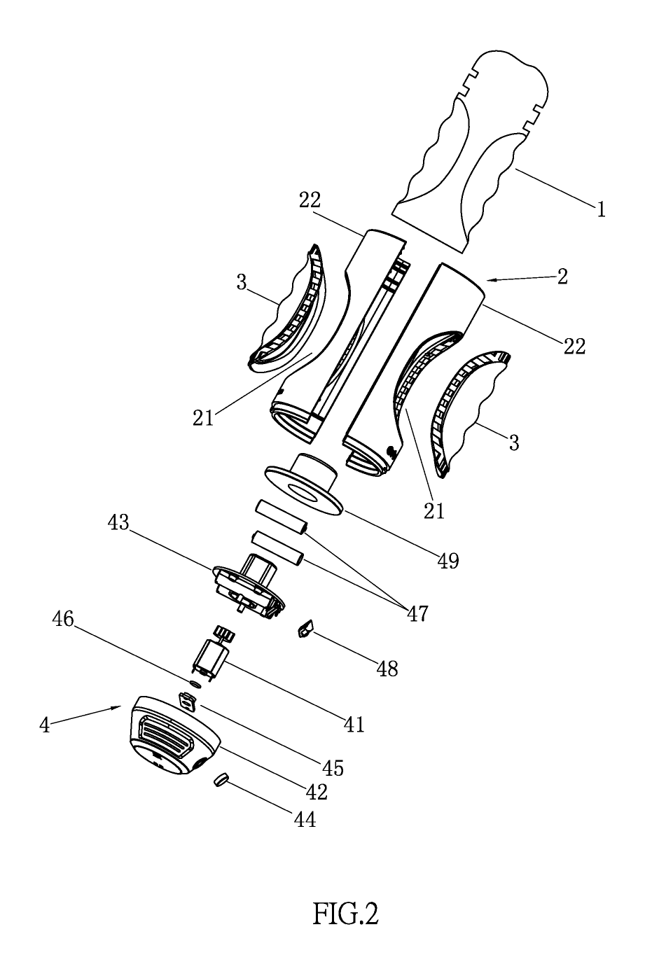

In FIGS. 1 and 2, the hard cup casing 2 is preferably a cylindrical casing, and the hard cup casing 2 is formed by two half cup casings 22 which are substantially two cylindrical casings, and the two half cup casings 22 are engaged with each other by an ultrasonic welding process to form the hard cup casing 2, and both of the two half cup casings 22 have the grasping recess 21 and the handholding soft pad 3. When the soft plastic body 1 is installed in the hard cup casing 2, the inner side of the handholding soft pad 3 is attached closely to the outer side of the soft plastic body 1. The hard cup casing 2 further comprises a vibrating device 4 installed therein, and the vibrating device 4 comprises a motor 41, a rear motor cover 42 installed at the rear of the motor 41, a motor battery compartment 43 installed at the front of the motor 41. The rear motor cover 42 and the motor battery compartment 43 are engaged with each other, and a switch button 44 is installed on an outer side of the rear motor cover 42, and a motor fixing plate 45 and a rubber ring 46 are installed in the rear motor cover 42, and a battery 47 is installed in the motor battery compartment 43, and a control circuit board 48 is installed on a side of the motor battery compartment 43, and a waterproof silicone cover 49 is installed at the front of the motor battery compartment 43. The handheld masturbation cup has the advantages of easy manufacture and convenient carry. Specifically, the manufacturing process of such handheld masturbation cup comprises the steps of: putting the two half cup casings 22 into an encapsulated mold cavity; injecting the TPU material into the mold cavity, such that a handholding soft pad 3 is formed on the half cup casing 22 by a secondary plastic injection molding process; engaging the two half cup casings 22 with each other by an ultrasonic welding process to form a hard cup casing 2 which is a substantially cylindrical casing; installing a vibrating device 4 into the rear of the hard cup casing 2; and installing the soft plastic body 1 into the front of the hard cup casing 2 to form the handheld masturbation cup (as shown in FIG. 1). When the handheld masturbation cup is used, a user's penis is inserted into the channel of the soft plastic body 1 for male masturbation, and then holds the handholding soft pad 3 to perform a thrusting or pressing motion while turning on the vibrating device 4 for a vibration effect, so as to reach an orgasm and achieve the masturbation effect. In addition, the masturbation cup may be turned inside out for cleaning and used repeatedly.

Wherein, the soft plastic body 1 may be detachably installed, so that after use, the soft plastic body 1 may be removed for cleaning. In addition, both of the outer side of the handholding soft pad 3 and the outer side of the soft plastic body 1 may come with a wavy-shaped grasping design to facilitate the user to grasp the masturbation cup and provide a better hand feel.

While this disclosure has been described by means of specific embodiments, numerous modifications and variations could be made thereto by those skilled in the art without departing from the scope and spirit of this disclosure set forth in the claims.

What is claimed is:

1. A handheld masturbation cup, comprising: a soft plastic body, a channel formed in the soft plastic body and provided for male masturbation, and a hard cup casing formed on an outer side of the soft plastic body, characterized in that grasping recesses are formed on both sides of the hard cup casing respectively, and the grasping recess has a handholding soft pad formed by a secondary plastic injection molding process, so that a user may press the soft plastic body through the handholding soft pad.

2. The handheld masturbation cup according to claim 1, wherein the soft plastic body is made of a TPR material, and the hard cup casing is made of an ABS plastic material, and the handholding soft pad is made of a TPU material.

3. The handheld masturbation cup according to claim 2, wherein the hard cup casing is a cylindrical casing, and the hard cup casing of the cylindrical casing is formed by two half cup casings which are half-cylindrical casings, and the two half cup casings are engaged with each other by an ultrasonic welding process, and both of the two half cup casings have the grasping recess and the handholding soft pad.

4. The handheld masturbation cup according to claim 3, wherein the inner side of the handholding soft pad is attached closely with the outer side of the soft plastic body when the soft plastic body is installed into the hard cup casing.

5. The handheld masturbation cup according to claim 1, wherein the hard cup casing further comprises a vibrating device installed therein, and the vibrating device comprises a motor installed to a rear motor cover situated at the rear of the motor, and a motor battery compartment installed at the front of the motor, and the rear motor cover and the motor battery compartment are engaged with each other, and a switch button is installed on an outer side of the rear motor cover, and a motor fixing plate and a rubber ring are installed in the rear motor cover, and a battery is installed in the motor battery compartment, and a control circuit board is installed on a side of the motor battery compartment, and a waterproof silicone cover is installed at the front of the motor battery compartment.
